(19) United States
(12) Patent Application Publication
(10) Pub. No.: US 2022/0101110 A1
(43) Pub. Date: Mar. 31, 2022

(54) PERSISTENT WEIGHTS IN TRAINING

(71) Applicant: Advanced Micro Devices, Inc., Santa Clara, CA (US)

(72) Inventors: Swapnil P. Sakharshete, San Diego, CA (US); Maxim V. Kazakov, San Diego, CA (US)

(73) Assignee: Advanced Micro Devices, Inc., Santa Clara, CA (US)

(21) Appl. No.: 17/032,971

(22) Filed: Sep. 25, 2020

(51) Int. Cl. G06N 3/08; G06N 3/04

(52) U.S. Cl. CPC G06N 3/08; G06N 3/04

(57) ABSTRACT

Techniques are disclosed for performing machine learning operations. The techniques include fetching weights for a first layer in a first format; performing matrix multiplication of the weights fetched in the first format with values provided by a prior layer in a forwards training pass; fetching the weights for the first layer in a second format different from the first format; and performing matrix multiplication for a backwards pass, the matrix multiplication including multiplication of the weights fetched in the second format with values corresponding to values provided as the result of the forwards training pass for the first layer.

### BACKGROUND

Machine learning operations involve computing and transmitting a large amount of data, which can place strain on computing resources. Improvements to computer resource usage for machine learning operations are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 illustrates details of the device and the APD, according to an example;

FIG. 3 is a block diagram illustrating additional details of a machine learning accelerator, according to an example;

FIG. 4 is a block diagram of a machine learning accelerator core, according to an example;

FIG. 5 illustrates connectivity between machine learning accelerator cores of a machine learning accelerator, according to an example; and

FIG. 6 is a flow diagram of a method for performing matrix operations, according to an example.

### DETAILED DESCRIPTION

Techniques are disclosed for performing machine learning operations in the case of training. The techniques include fetching weights for a first layer in a first format; performing matrix multiplication of the weights fetched in the first format with values provided by a prior layer in a forwards training pass; fetching the weights for the first layer in a second format different from the first format; and performing matrix multiplication for a backwards pass, the matrix multiplication including multiplication of the weights fetched in the second format with values corresponding to values provided as the result of the forwards training pass for the first layer.

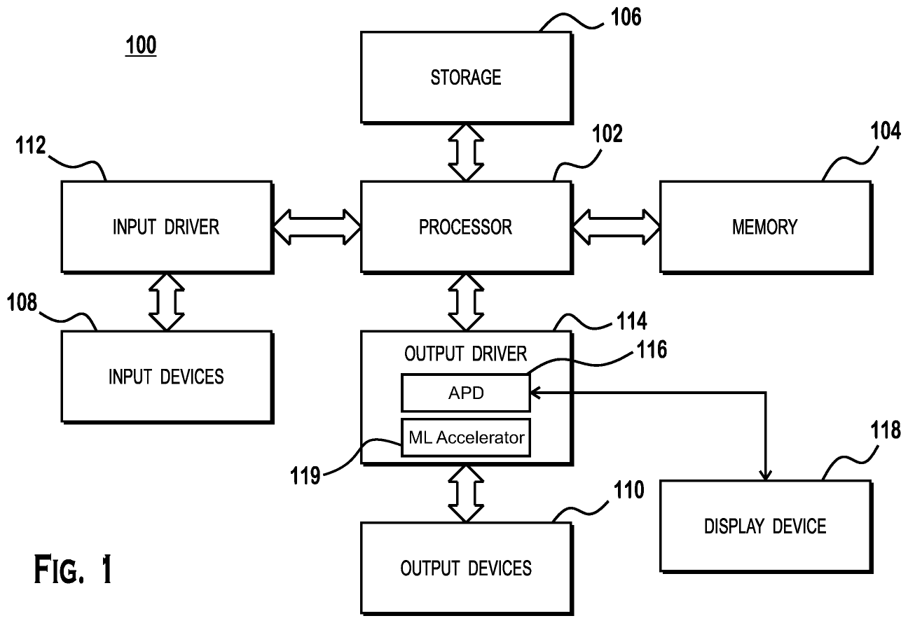

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. In some implementations, the output driver 114 includes an accelerated processing device (“APD”) 116 which is coupled to a display device 118, which, in some examples, is a physical display device or a simulated device that uses a remote display protocol to show output. In some implementations, the APD 116 is configured to accept one or more of compute commands and graphics rendering commands from processor 102, to process those compute and graphics rendering commands, and to provide pixel output to display device 118 for display. In some implementations, the APD 116 does not have graphics processing capabilities and thus does not include a graphics processing pipeline 134.

As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118. For example, it is contemplated that any processing system that performs processing tasks in accordance with a SIMD paradigm may be configured to perform the functionality described herein. Alternatively, the functionality described herein may be incorporated in processor 102, associated CPU and/or GPU or any hardware accelerator, including machine learning accelerator. Alternatively, it is contemplated that computing systems that do not perform processing tasks in accordance with a SIMD paradigm performs the functionality described herein.

The output driver 114 includes a machine learning accelerator 119. The machine learning accelerator includes processing components (such as circuitry and/or one or more processors that execute instructions) that perform machine learning operations. In some examples, machine learning operations include performing matrix multiplications or performing convolution operations. In some implementations, the machine learning accelerator 119 is integrated within the APD 116.

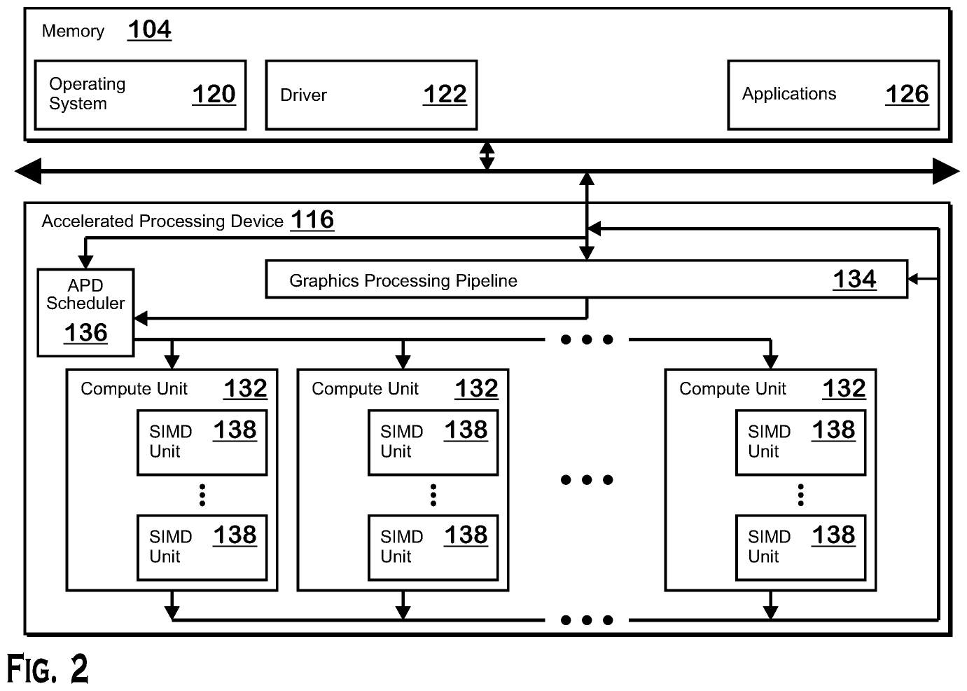

FIG. 2 illustrates details of the device 100 and the APD 116, according to an example. The processor 102 (FIG. 1) executes an operating system 120, a driver 122, and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102. In some examples, these compute processing operations are performed by executing compute shaders on the SIMD units 138.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. An APD command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The graphics processing pipeline 134 includes hardware that performs graphics rendering, in some implementations using the compute units 132 to perform tasks such as executing shader programs. In general, the graphics rendering operations include converting geometry specified in a three-dimensional word space into pixels of a screen space for display or other use. In various examples, the graphics processing pipeline 132 performs the operations of one or more of a vertex shader stage, which executes vertex shader programs on the compute units 132, a hull shader stage, which executes hull shader programs on the compute units 132, a domain shader stage, which executes domain shader programs on the compute units 132, a geometry shader stage, which executes geometry shader programs on the compute units 132, and a pixel shader stage, which executes pixel shader programs on the compute units 132. The APD 116 is also capable of performing compute shader programs, which are not included in the typical functionality of the graphics processing pipeline 134, on the compute units 132.

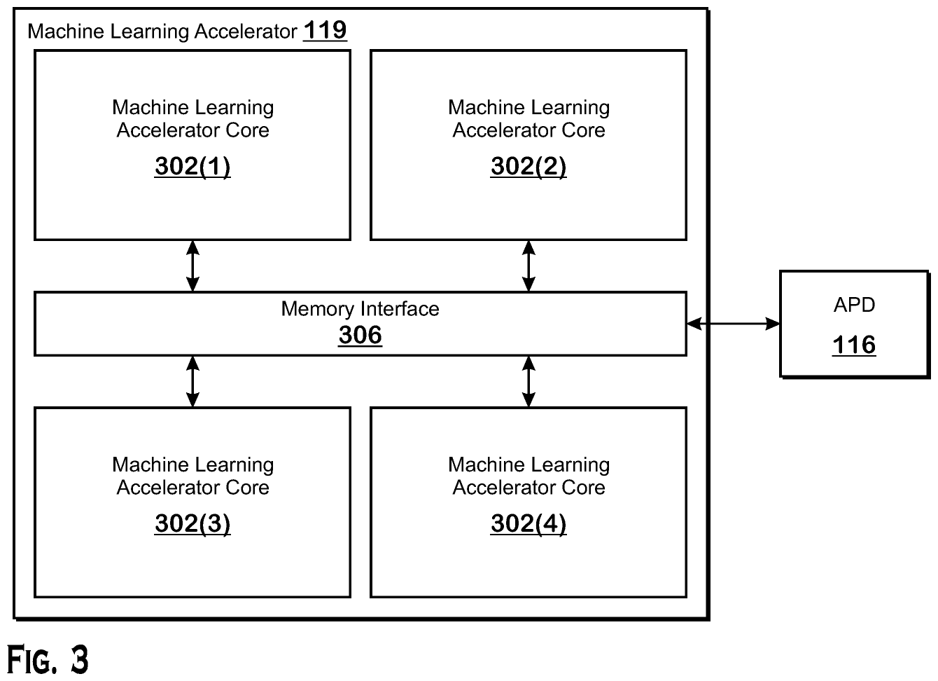

FIG. 3 is a block diagram illustrating additional details of the machine learning accelerator (“ML accelerator”) 119, according to an example. The ML accelerator 119 includes one or more machine learning accelerator cores 302. In some examples, the machine learning accelerator cores 302 include circuitry for performing matrix multiplications. The machine learning accelerator 119 also includes a memory interface 306. The memory interface 306 communicably couples the machine learning accelerator memory 304 to external components such as the APD 116 and memory 104.

The APD 116 and ML accelerator 119 implement machine learning operations including training and inference operations. Inference operations include applying inputs to a machine learning network and obtaining a network output such as a classification or other output. Training operations include applying training inputs to a machine learning network and modifying the weights of the network according to a training function.

As is generally known, a machine learning network includes a series of one or more layers. Each layer applies one or more operations such as a general matrix multiply, a convolution, a step function, or other operations, and provides an output. Some layer types implement operations that model artificial neurons. More specifically, some layer types implement operations in which inputs to the layer are provided to one or more artificial neurons. Each artificial neuron applies a weight to inputs, sums the weighted inputs, and, optionally, applies an activation function. The weighted sums of neuron inputs are implemented as matrix multiplications performed within the machine learning accelerator core 302. In another example, a layer implements convolutions. A convolution includes multiple instances of performing a dot product of a filter with a set of pixel values from an image. Because multiple of these dot products are performed, convolution operations are mapped to matrix multiplication operations on the machine learning accelerator cores 302. It should be understood that although matrix multiplication operations are generally described as being performed by the machine learning accelerator cores 302, in various alternative implementations, these cores 302 perform additional and/or alternative operations as well.

During training, a forward pass and a backwards pass are performed. The forwards pass processes network inputs to generate network outputs. The forwards pass involves generating outputs or “activation values” for different layers. In some examples, each activation value is the output of a single artificial neuron. The backwards pass involves applying weight adjustments to the various layers based on a correction function. The backwards pass also uses the activation values generated by the forward pass in adjusting these weights. More specifically, at each layer, the backwards pass attempts to determine an error of the actual activation values, and adjusts weights at that layer based on that error.

As stated above, during training, values from the forwards pass—the weights—are used in both forwards and backwards passes. The forwards pass generates activation values for the layers of the network. During the forwards pass, inputs to each layer are processed with weights for that layer to generate outputs for the layer. The backwards pass includes a data gradient step and a weight gradient step. The data gradient step uses back-propagation to calculate the loss with respect to a loss function for each of the layers. More specifically, the data gradient calculates a loss for each layer output. For the last layer, the loss represents a measure of difference with the “desired” output. For layers prior to the last layer, back-propagation generates losses for individual layout output values based on losses from later layers. This step is called a data gradient because the step generates losses of the layer outputs with respect to “desired” layer outputs as determined by the backpropagation. A subsequent weight gradient step calculates adjustments to the weights in order to achieve the layer output values determined by the data gradient step.

The weight values used for the forward and the data gradient of the backwards passes are the same values. Thus, it would be advantageous to retain or “pin” these weights to the machine learning accelerator cores 302 between these forwards and backwards passes. However, the manner in which the weights are actually utilized by the machine learning accelerator cores 302 for the forwards and backwards passes is not the same. More specifically, the matrix multiplication operations that occur in the forwards pass are not the same as the matrix multiplication operations that occur in the backwards pass, even though the values of the weights are the same. Moreover, the shape of the weight matrix is different for the backwards and forwards pass. Thus, it is not possible to use the exact same weight data in the same format for both forwards and backwards pass.

In addition, backwards and forwards matrix multiplication operations often involve the generation of partial matrix products and a subsequent summing over such partial matrix products. These partial multiplication and summing operations occur due to the possibility of the input and/or output matrices being of a size that is greater than the size capacity of the hardware matrix multipliers of the machine learning accelerator cores 302.

In a straightforward partitioning strategy, an output matrix having dimensions M×N is equally divided among all machine learning accelerator cores 302 for maximum utilization of all cores. With this partitioning scheme for a layer in a forward pass, each machine learning core 302 is assigned a partition having dimensions K×N′. In addition, each machine learning accelerator core 302 is assigned a portion of a weight matrix for multiple layers of a network. This portion of the weight matrix is stored into a local memory of each machine learning core 302. While performing a data gradient matrix multiplication during a backward pass, the weight matrix is fed in a transposed way, in which the N′ dimension is a different dimension than in the forward pass. Due to the pinning of the weights during the forward pass, meaning that certain specific weights are assigned to each machine learning accelerator core 302, the machine learning accelerator cores 302 each generate partial products during the data gradient phase of the backwards pass.

In an example, a large matrix is divided into smaller sub-matrices. The sub-matrices are multiplied together to form partial matrix products and these partial matrix products are added together. It is convenient to map the different partial matrix multiplication operations to different machine learning accelerator cores 302 for parallelization and then to forward the partial matrix products to a smaller subset of machine learning accelerator cores 302 for summation. However, due to the difference in operations that occur for backwards and forwards passes, convenient machine learning accelerator cores 302 that are to receive the partial matrix products for summation are different in the backwards and forwards passes.

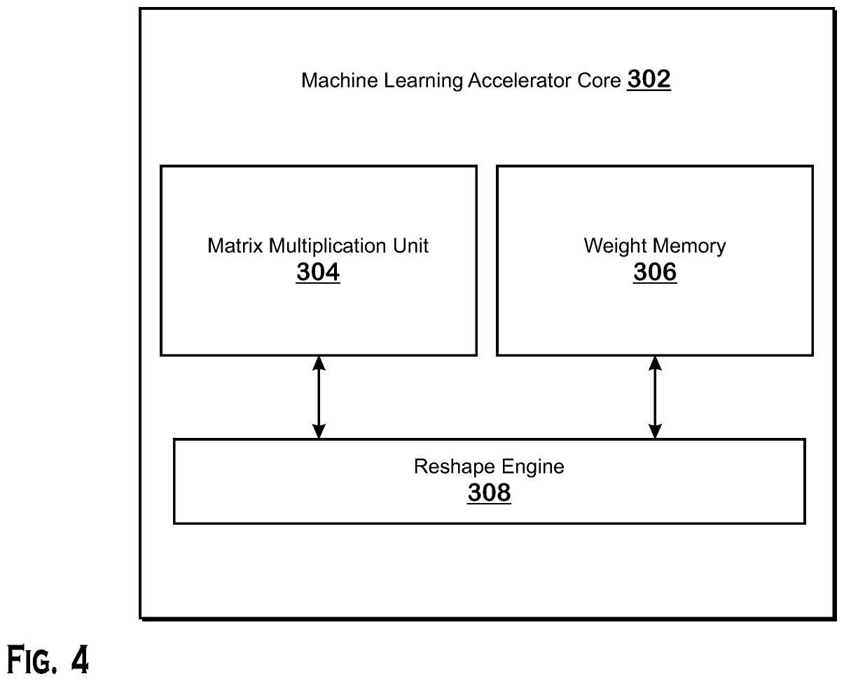

FIG. 4 is a block diagram of a machine learning accelerator core 302, according to an example. The machine learning accelerator core 302 includes a matrix multiplication unit 304, a weight memory 306, and a reshape engine 308. The reshape engine 308 is configured to provide weight data from the weight memory 306 in several different data formats to support both backwards and forwards propagation for various machine learning operations such as general matrix multiply (“GEMM”) and convolutions. The weight memory 306 is configured to store (“pin”) weights through one or even multiple backwards and forwards passes such that the weights do not need to be moved out to memory (such as memory 104) and read back in in between forwards and backwards passes. The matrix multiplication unit 304 performs matrix multiplications for general matrix multiply, convolutions, or, possibly, other operations.

The reshape engine 308 is configured to provide weights from the weight memory 306 to the matrix multiplication unit 304 in a certain format based on whether the machine learning accelerator core 302 is performing operations for a forward pass or a backward pass. The specific reshape operation is programmable and, in some implementations, is dependent on the type of operation being performed on the machine learning accelerator core 302 (for example, the forwards pass or the backwards pass).

Matrix multiplication is dependent on the format of the input matrices. More specifically, in standard matrix multiplication, a first matrix is multiplied by a second matrix to obtain a product. For a matrix multiplication to be valid, the two matrices must have a single dimension that is the same size. The output matrix has dimensions equal to the non-common dimensions of the first and second matrix. For example, if a 4×5 matrix is multiplied by a 4×3 matrix, the resulting matrix is a 3×5 matrix, since 4 is the common dimension and 3 and 5 are the other dimensions. In general, a matrix multiplication is performed by performing a dot product of the rows of the first matrix with the columns of the second matrix. An element in the result matrix at row r and column c is the dot product of row r of the first matrix and column c of the second matrix. The common dimension is the number of columns of the first matrix and the number of rows of the second matrix.

With general matrix multiply for a forwards pass, results (which may be outputs or may be transformed into outputs) for a current layer are generated by multiplying a matrix including outputs from a previous layer and a matrix including weights for the current layer. The implementation of general matrix multiplication for machine learning is software-defined. More specifically, programmer-specified software divides the previous layer outputs and weights for the current layer into matrices that are then provided to the machine learning accelerator core 302 for multiplication. In addition, the programmer-specified software often “batches” together data from the same layer but different forward pass iterations. Values from different batches are sometimes grouped together into the matrices that are provided to the machine learning accelerator core 302 for multiplication. By convention, the matrix for the outputs from the previous layer (the input to the multiplication for the current layer) is said to have K columns and M rows. In addition, the weights matrix is said to have N columns and K rows. K is therefore the common dimension. The result matrix, which is the result of matrix multiplication, has N columns and M rows.

The backwards pass data gradient step for a given layer involves multiplying modified outputs from the layer by the weights for that layer to generate modified outputs for a previous layer. The outputs are “modified” in the sense that the outputs are different than the outputs generated by the forwards pass. The differences are the result of accounting for the loss function for subsequent functions. The matrices to be multiplied together have the following dimensions. The matrix having the modified outputs has N columns and M rows, which are the same dimensions as the matrix having outputs generated in the forwards pass. The weights matrix has K columns and N rows. The result matrix has K columns and M rows.

Note that the weights matrix for the backwards pass is the transpose of the weight matrix for the forwards pass. A matrix is a transpose of another matrix in the case that the rows and columns of the elements of the original matrix are reversed in the transposed matrix. For this reason, for general matrix multiply, the reshape engine 308 is configured to provide, to the matrix multiplication unit 304, the weight matrix pinned in the weight memory 306 in a non-transposed format during a forward pass and to provide the weight matrix in a transposed format during a backwards pass. The matrix multiplication unit 304 performs matrix multiplications with the weight matrix and inputs from a previous layer, in a forward pass for general matrix multiply, and performs matrix multiplications with a transposed version of the weight matrix and inputs from a subsequent layer, in a backwards pass.

In some implementations, the reshape engine 308 is instructed by software to provide a weight matrix to the matrix multiplication unit 304 in either a transposed or non-transposed format. In an example, software that orchestrates overall control flow of the forwards pass and data gradient of the backwards pass executes on a processor such as the APD 116 or the processor 102. In such an example, this software defines what matrix multiplications are to be performed in the passes. During the forward pass, this software instructs the reshape engine 308 to provide the weight matrix to the matrix multiplication unit 304 in a non-transposed format for the forwards pass and to provide the weight matrix to the matrix multiplication unit 304 in a transposed format for the backwards pass.

The matrix multiplication unit 304 is also configured to perform matrix multiplications for convolutions. As is generally known, convolutions involve convolving an image with a set of filters to obtain an output image. “Convolving” an image with a filter means performing a dot product with of a portion (“filter cutout”) of the input image with a filter to obtain an output element for an output image. For each input image, multiple filter cutouts are convolved with the filter, and each such individual convolution operation generates an individual element of an output image. In some implementations, the input image and filters include multiple channels, and the convolution operation includes forming an output image based on the convolution of each filter channel with each image channel. In some implementations, convolution operations are performed with multiple batches. Each batch is an instance of a convolution operation, each of which may have one or multiple filter channels. Mathematically, convolutions including multiple batches can be performed by multiplying two matrices, each of which includes data for the multiple batches.

A convolution operation is mapped to a matrix multiplication in the following manner. A first matrix includes input activations and a second matrix includes weights (filters). The first matrix—the activation matrix—has N×P×Q rows and C×R×S columns. N is the number of batches. P is the width of the output image. Q is the height of the output image. C is the number of input channels. R is the height of the filter. S is the width of the filter. The second matrix—the weight matrix—has C×R×S rows and K columns. K is the number of output channels. The output has K columns and N×P×Q rows.

In the forwards pass, the first matrix multiplied by the second matrix produces results for N×K output images. In other words, the multiplication produces a number of output images equal to the number of batches times the number of output channels.

In the backwards pass for data gradient calculations of a given layer, the first input matrix, representing the error gradient propagated from the preceding layer for the layer, has K×R×S columns and N×P×Q rows. The second matrix—the weights matrix—has C columns and K×R×S rows. In other words, the result of this matrix multiplication produces N×C output images, which is the same as the input activation size during the forward pass of this layer. Note that the common dimension is K×R×S. Note also that in the backwards pass, the weights matrix is reshaped with respect to the weights matrix in the forwards pass. More specifically, in the forwards pass, each column corresponds to a single output channel (K) and includes the weights for multiple input channels (C). By contrast, in the backwards pass, each column corresponds to a single input channel (C) and includes the weights for multiple output channels (K). The result of the multiplication includes a matrix having C columns and N×P×Q rows.

As with the general matrix multiply operation, with the convolution operation, software, such as software that orchestrates the backwards and forwards pass and is executing on a processor such as processor 102 or APD 116, indicates the manner in which the reshape engine 308 provides the weight values stored in the weight memory 306 to the matrix multiply unit 304 for multiplication. During the forward pass, the software indicates to the reshape engine 308 to provide the weights in the format of C×R×S rows and K columns. During the backwards pass, the software indicates to the reshape engine 308 to provide the weights in the format of K×R×S rows and C columns.

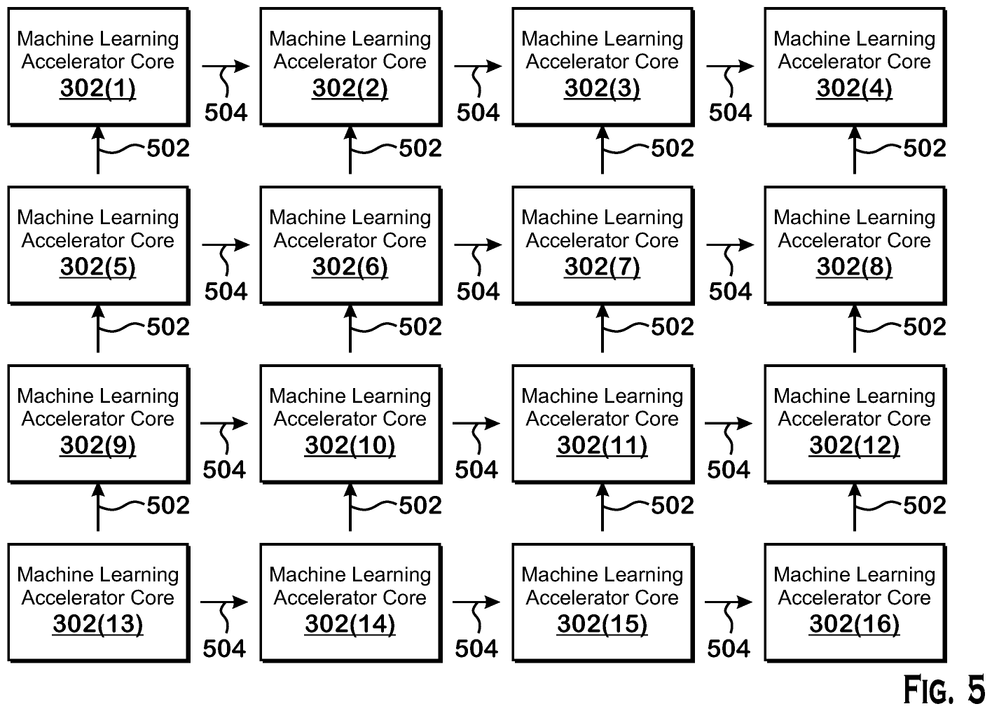

FIG. 5 illustrates connectivity between machine learning accelerator cores 302 of a machine learning accelerator 119, according to an example. The machine learning accelerator cores 302 are arranged in rows and columns. For example, one row includes core 302(1), core 302(2), core 302(3), and core 302(4). One column includes core 302(1), core 302(5), core 302(9), and core 302(13). The machine learning accelerator 119 include connections between cores 302. The connections include horizontal connections 504 that distribute data within rows and vertical connections 502 that distribute data within columns.

As described elsewhere herein, a matrix multiplication operation such as the matrix multiplication operation used for general matrix multiply and for convolutions, is performed in the cores 302 as a combination of partial matrix multiplications. More specifically, larger matrices are split into smaller matrices. The cores 302 perform matrix multiplications for these smaller matrices to obtain partial matrix products. Subsequently, the cores 302 add these partial matrix products to obtain a full matrix multiplication.

The connections, including the horizontal connections 504, and vertical connections 502, serve to forward the partial matrix products to cores 302 assigned to sum those partial matrix products. The specific cores 302 that sum specific partial matrix products are customizable by software. Software determines which cores 302 are to receive the partial matrix products for summation and directs the cores 302 that generate those partial matrix products to forward those partial matrix products to the determined cores 302 via the connections.

Note that the weight pinning that occurs means that weights are to remain in a single core 302 rather than being moved between cores 302, during both the forward pass and the backwards pass. However, because the matrix multiplications that are performed in the backwards and forwards passes are different, the cores 302 selected to forward partial matrix products to particular other cores 302 for summation differ between the backwards and forwards passes. In an example, during the forwards pass, software selects the right-most cores 302 to receive the partial matrix products for summation, directs the cores 302 to generate the partial matrix products through matrix multiplication, directs the cores 302 to transmit the partial matrix products to the right-most cores 302 for summation, and directs the right-most cores 302 to sum those products. During the backwards pass, software selects the top-most cores 302 to receive the partial matrix products for summation, directs the cores 302 to generate the partial matrix products through matrix multiplication, directs the cores 302 to transmit the partial matrix products to the top-most cores 302 for summation, and directs the top-most cores 302 to sum those partial matrix products. In sum, the machine learning accelerator 119 includes connections that allow software to select the manner in which partial matrix products are accumulated for final summation, and the manner in which partial matrix products are accumulated differs for different passes.

In some implementations, the connections illustrated are unidirectional. Thus in some implementations, the cores 302 transmit partial products for summation in one of two directions, rather than in one of four directions.

The phrase “software performs an action” or similar phrase, when used herein, should be understood to mean that software executing on a processor, such as the processor 102 or the APD 116, performs the action.

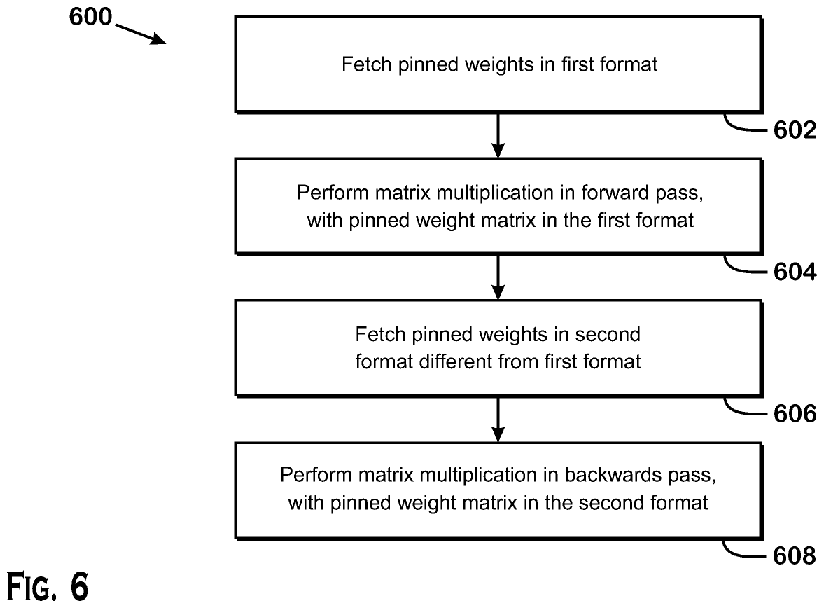

FIG. 6 is a flow diagram of a method 600 for performing matrix operations, according to an example. Although described with respect to the system of FIGS. 1-5, those of skill in the art will understand that any system configured to perform the steps of the method 600, in any technically feasible order, falls within the scope of the present disclosure.

At step 602, a machine learning accelerator core 302 fetches pinned weights in a first format. The format dictates the manner in which matrix multiplication occurs. In some implementations, this fetch occurs at the direction of software executing on a processor such as processor 102 or the APD 116.

At step 604, the core 302 performs matrix multiplication with the weights fetched in the first format. In some examples, the matrix multiplication is part of a general matrix multiply operation or a convolution operation. In either example, the weights are multiplied by outputs from a previous layer.

At step 606, the core 302 fetches the pinned weights in a second format. The weight values fetched are the same as those fetched in step 602, but the format in which the weights are fetched is different. This different format allows the weights to be used in a backpropagation pass, which requires a matrix having a different format. In some examples, the different format is a transpose of the first format. In other examples, the different format is a reshape format suitable for a convolution operation as described elsewhere herein. At step 608, the core 302 performs the matrix multiplication for the backwards pass, with the weights in the second format.

Each of the units illustrated in the figures represents one or more of hardware configured to perform the described operations, software executable on a processor, wherein the software is configured to perform the described operations, or a combination of software and hardware. In an example, the storage 106, memory 104, processor 102, display device 18, output driver 114, APD 116, ML accelerator 119, output devices 110, input driver 112, and input devices 108, are all hardware circuitry that perform the functionality described herein. In an example, all elements of the APD 116 are hardware circuitry that perform the functions described herein. In various examples, the elements of the ML accelerator 119, including the machine learning accelerator core 302, the matrix multiplication unit 304, and the memory interface 306 are hardware circuitry that perform the functions described herein.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a graphics processor, a machine learning processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method, comprising:
fetching weights for a first layer in a first format;
performing matrix multiplication of the weights fetched in the first format with values provided by a prior layer in a forwards training pass;
fetching the weights for the first layer in a second format different from the first format; and
performing matrix multiplication for a backwards pass, the matrix multiplication including multiplication of the weights fetched in the second format with values corresponding to values provided as the result of the forwards training pass for the first layer.

2. The method of claim 1, wherein the first layer is a general matrix multiply layer.

3. The method of claim 2, wherein the weights in the second format are organized as a matrix that is a transpose of the weights in first format.

4. The method of claim 1, wherein the first layer is a convolution layer.

5. The method of claim 4, wherein the weights in the second format are organized as a matrix that is a convolution-based reshape of the weights in the first format, wherein, in the convolution-based reshape, columns include filters in the same input channel while in the weights in the first format, columns include filters in the same output channel.

6. The method of claim 1, wherein:
the forward training pass and the backwards pass include a plurality of matrix multiplication sub-operations involving portions of a larger matrix, each matrix multiplication sub-operation occurring on a machine learning accelerator core and generating a partial matrix multiplication result; and
the method further comprises:
selecting one or more connections between machine learning accelerator cores through which to accumulate partial matrix multiplication results for summation.

7. The method of claim 6, wherein selecting the one or more connections comprises:
selecting a first set of connections for the forward training pass and selecting a second set of connections for the backwards pass.

8. The method of claim 6, wherein the one or more connections are unidirectional.

9. The method of claim 1, wherein the weights are pinned in a machine learning accelerator core between the forwards pass and the backwards pass.

10. A machine learning accelerator core, comprising:
a matrix multiplication unit;
a reshape engine; and
a weight memory,
wherein the matrix multiplication unit is configured to:
fetch weights for a first layer in a first format from the reshape engine;
perform matrix multiplication of the weights fetched in the first format with values provided by a prior layer in a forwards training pass;
fetch, from the reshape engine, the weights for the first layer in a second format different from the first format; and
perform matrix multiplication for a backwards pass, the matrix multiplication including multiplication of the weights fetched in the second format with values corresponding to values provided as the result of the forwards training pass for the first layer.

11. The machine learning accelerator core of claim 10, wherein the first layer is a general matrix multiply layer.

12. The machine learning accelerator core of claim 11, wherein the weights in the second format are organized as a matrix that is a transpose of the weights in first format.

13. The machine learning accelerator core of claim 10, wherein the first layer is a convolution layer.

14. The machine learning accelerator core of claim 13, wherein the weights in the second format are organized as a matrix that is a convolution-based reshape of the weights in the first format, wherein, in the convolution-based reshape, columns include filters in the same input channel while in the weights in the first format, columns include filters in the same output channel.

15. The machine learning accelerator core of claim 10, wherein the weights are pinned in the weight memory between the forwards training pass and the backwards pass.

16. A machine learning accelerator, comprising:
a plurality of machine learning accelerator core, wherein each machine learning accelerator core of the plurality of machine learning accelerator cores comprises:
a matrix multiplication unit;
a reshape engine; and
a weight memory,
wherein the matrix multiplication unit is configured to:
fetch weights for a first layer in a first format from the reshape engine;
perform matrix multiplication of the weights fetched in the first format with values provided by a prior layer in a forwards training pass;
fetch, from the reshape engine, the weights for the first layer in a second format different from the first format; and
perform matrix multiplication for a backwards pass, the matrix multiplication including multiplication of the weights fetched in the second format with values corresponding to values provided as the result of the forwards training pass for the first layer.

17. The machine learning accelerator of claim 16, wherein:
the forward training pass and the backwards pass include a plurality of matrix multiplication sub-operations involving portions of a larger matrix, each matrix multiplication sub-operation occurring on a machine learning accelerator core and generating a partial matrix multiplication result; and
one or more machine learning accelerator core of the plurality of machine learning accelerator cores is configured to:
select one or more connections between machine learning accelerator cores through which to accumulate partial matrix multiplication results for summation.

18. The machine learning accelerator of claim 17, wherein selecting the one or more connections comprises:
selecting a first set of connections for the forward training pass and selecting a second set of connections for the backwards pass.

19. The machine learning accelerator of claim 17, wherein the one or more connections are unidirectional.

20. The machine learning accelerator of claim 17, wherein the weights are pinned in a machine learning accelerator core between the forwards pass and the backwards pass.
